(19) United States
(12) Patent Application Publication
(10) Pub. No.: US 2009/0023086 A1
(43) Pub. Date: Jan. 22, 2009

(54) RECORDING MEDIUM FOR ELECTROPHOTOGRAPHIC PRINTER

(75) Inventor: Jae-hwan KIM, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/028,148

(22) Filed: Feb. 8, 2008

(30) Foreign Application Priority Data
Jul. 19, 2007 (KR) 2007-72473

(51) Int. Cl. G03G 9/087

(52) U.S. Cl. 430/109.3

(57) ABSTRACT

A recording medium for an electrophotographic printer is provided. The recording medium includes a substrate and a toner receiving layer formed on at least one surface of the substrate. The toner receiving layer includes a white pigment, an acryl based emulsion latex and polyvinyl alcohol, and an average viscosity of the polyvinyl alcohol is less than 25 cps in a 4% aqueous solution maintained at 20° C.

### CROSS-REFERENCE TO RELATED APPLICATIONS

This application claims priority under 35 U.S.C. §119(a) from Korean Patent Application No. 10-2007-0072473, filed on Jul. 19, 2007, in the Korean Intellectual Property Office, the disclosure of which is incorporated herein in its entirety by reference.

### BACKGROUND OF THE INVENTION

1. Field of the Invention

The present general inventive concept relates to a recording medium for an electrophotographic printer, and more particularly to a recording medium for an electrophotographic printer which can be used to achieve a high production yield and enhanced image quality with a uniform coating.

2. Description of the Related Art

With the recent developments of computer technology, computer-based data preparations and print-outs have become widespread. For example, to print-out data by the use of computers, a dot impact printer, a laser beam printer, a thermal transfer printer, and an inkjet printer can be used. Specifically, a printing method utilizing laser beams (electrophotography) has gained widespread acceptance by consumers in the printing industry because the printing method is fast and is a relatively inexpensive form of printing, and yet the printing method produces high resolution printed images.

An electrophotographic process used for the printers listed above or for copying machines involves a series of steps, generally five steps of charging, exposure, development, transfer, fusing, and cleaning, and erasure, to form an image. In the first step, charges of a specific polarity are formed on a photoconductor drum or belt in darkness. In the second step, laser beams are irradiated onto the photoconductor drum or belt, thereby forming a latent image. In the third step, the latent image is exposed to charged toner particles. The toner particles adhere to the latent image via electrostatic forces to then be transferred imagewise onto the photoconductor drum or belt. In the fourth step, while a recording medium is fed between the photoconductor drum or belt and a corona charging device, the toner particles are transferred to the recording medium. Here, the recording medium should have an appropriate conductivity so that a toner image can be transferred to the recording medium using an electrostatic force. In the fifth step, the toner image transferred to the recording medium is fixed through a hot fusing process in which heat and pressure are applied to the toner image by means of a roller.

In the electro-photolithography, various types of recording media including ordinary paper, specially coated paper such as art paper, cast-coated paper, or resin-coated paper, are commonly used.

A variety of sheets for electro-photolithgraphy of a coating with improved toner fixability have been developed. For example, Japanese Published Patent Document Nos. 2004-101980 and 2004-138997 disclose a method of providing an image with improved quality by improving offset resistance or crack resistance by incorporating latex or aqueous acryl vanish into a toner receiving layer. However, the disclosed methods primarily describe techniques for improving coatings in conjunction with toner materials. Accordingly, there still exists a demand in the related industry for techniques that yield coating solutions with flowability for better coating workability during fabrication of coating products, stability and more uniform coating characteristics.

Preparation processes of a coating solution for forming the recording medium for an electrophotographic printer may vary according to the coating method of the toner receiving layer forming the recording medium. If flowability and stability of the coating solution for forming a coating receiving layer are increased even with substantially the same composition for forming the toner receiving layer, product quality of coatings can be enhanced. A general recording medium for an electrophotographic printer having a toner receiving layer is formed by applying an inorganic coating solution to raw paper. One widely known coating method is a blade coating method. Since the blade coating method has a high coating speed, the blade coating method can be advantageously used in terms of cost and mass production. If the coating speed is increased during a coating process, a shear stress increases. However, in the case of using a coating solution with poor flowability, a high shear stress is applied to the coating solution during a blade coating process, so that adjustment of an appropriate coating rate is difficult. Accordingly, the coating solution preferably has pseudo plastic flow characteristics and the viscosity of the coating under a blade decreases to enhance coating workability.

If the flowability of the coating solution is optimized, occurrence of streaks can be reduced and breakage of the paper web can also reduced. Further, uniformity in a coating process can be ensured, thereby facilitating picture quality.

### SUMMARY OF THE INVENTION

The present general inventive concept provides a recording medium for an electrophotographic printer which can be used to achieve a high production yield and enhanced image quality with a uniform coating.

The present general inventive concept also provides a composition to form a toner receiving layer of the recording medium for an electrophotographic printer.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a recording medium usable with an electrophotographic printer, the recording medium including a substrate and a toner receiving layer formed on at least one surface of the substrate, wherein the toner receiving layer includes a white pigment, an acryl based emulsion latex and polyvinyl alcohol, and an average viscosity of the polyvinyl alcohol is less than 25 cps in a 4% aqueous solution maintained at 20° C.

The average viscosity of polyvinyl alcohol may be in a range from 1.5 to 25 cps in a 4% aqueous solution maintained at 20° C.

The average viscosity of polyvinyl alcohol may range from 3 to 20 cps in a 4% aqueous solution maintained at 20° C.

The toner receiving layer may include 100 parts by weight of the acryl based emulsion latex, 1 to 100 parts by weight of polyvinyl alcohol and 100 to 6,000 parts by weight of the white pigment.

The glass transition temperature (Tg) of the acryl based emulsion latex may be equal to or lower than about 40° C.

A number average molecular weight of the acryl based emulsion latex may be in a range from about 10,000 to about 5,000,000.

The acryl based emulsion latex may be at least one selected from the group consisting of polyacrylate emulsions, styrene-acrylic copolymer emulsions and polyvinylacetate-acrylate copolymer emulsions.

The toner receiving layer may further include polyethylene glycol.

A content of polyethylene glycol may be in a range of 10 to 200 parts by weight per 100 parts by weight of the acryl based emulsion latex.

A number average molecular weight of polyethylene glycol may be in a range from about 150 to about 1,500.

The toner receiving layer may further include a defoamer.

A content of the defoamer may be in a range of 0.001 to 2 parts by weight per 100 parts by weight of the acryl based emulsion latex.

The defoamer may include a phosphate based compound.

The toner receiving layer may include one or more materials selected from the group consisting of polyvinylpyrrolidone, methyl cellulose, hydroxypropylmethyl cellulose, gelatin, polyethylene oxide, acryl based polymer, polyester, polyurethane, epoxy resin, styrene-butadiene based latex, vinyl nitrate based latex, methyl(meth)acrylate-butadiene based latex and quaternary ammonium-based copolymer.

The toner receiving layer may be formed on both surfaces of the substrate.

The foregoing and/or other aspects and utilities of the general inventive concept may also be achieved by providing a composition to form a toner receiving layer including a white pigment, an acryl based emulsion latex, polyvinyl alcohol and a solvent, wherein an average viscosity of polyvinyl alcohol is less than 25 cps in a 4% aqueous solution maintained at 20° C.

The composition may include the acryl based emulsion latex in a content of about 100 parts by weight, polyvinyl alcohol in a content ranging from about 1 to about 100 parts by weight, the white pigment in a content ranging from about 100 to about 6,000 parts by weight, and the solvent in a content ranging from about 100 to about 10,000 parts by weight.

The solvent may be one or more materials selected from the group consisting of water, ketones, glycol ethers, alcohols, methyl cellosolves, ethyl cellosolves, dimethylformamides, and dimethylsulfoxides.

A solid content of the composition is equal to or greater than 30 parts by weight.

A solid content of the composition is in a range of about 40 to about 80 parts by weight.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates a recording medium for an electrophotographic printer having a layered structure according to an embodiment of the present general inventive concept; and

FIG. 2 illustrates a recording medium for an electrophotographic printer having a layered structure according to another embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

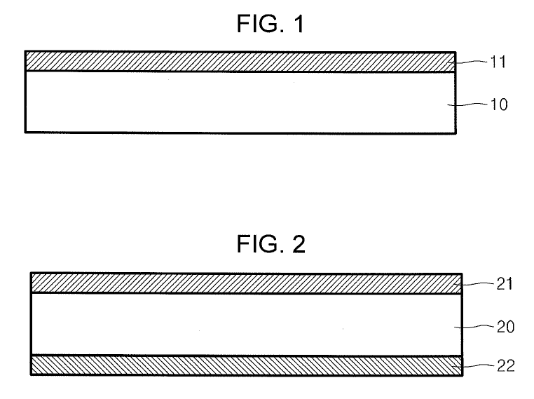

A recording medium for an electrophotographic printer according to embodiments of the present general inventive concept includes a substrate 10 and 20 and a toner receiving layer 11, 21 and 22. According to an embodiment of the present general inventive concept, as illustrated in FIG. 1, a toner receiving layer 11 may be formed on one surface of a substrate 10. In an alternative embodiment of the present general inventive concept, as illustrated in FIG. 2, toner receiving layers 21 and 22 may be formed on either surface of a substrate 20. Each of the toner receiving layers 11, 21, and 22 according to the embodiments as illustrated in FIGS. 1 and 2 includes a white pigment, an acryl based emulsion latex and polyvinyl alcohol, wherein the polyvinyl alcohol has an average viscosity of less than 25 cps in a 4% aqueous solution maintained at 20° C.

According to the embodiments of FIGS. 1 and 2, an appropriate binder is prepared by taking above-described characteristics into consideration. In view of costs and working efficiency, latex can be used as a binder for art paper or coated paper as a recording medium for an electrophotographic printer. Although the latex structurally exhibits pseudo plastic flow characteristics, the latex has relatively high content solid particles, so that solid particles therefrom interfere with pigment particles at an increased shear rate, and as such demonstrating dilatant rheological behaviors. Accordingly, since a coating solution containing latex only is barely affected by interference between latex particles and pigment particles at a low shear rate, the coating solution exhibits pseudo plastic flow characteristics. However, the coating solution is highly likely to exhibit dilatant flow characteristics due to an increase in the interference between latex particles and pigment particles at a high shear rate. Accordingly, in order to overcome this shortcoming, the present general inventive concept proposes use of a combination of an aqueous polymer, e.g., polyvinyl alcohol (PVA), and the latex. An exemplary optimal combination is to use acrylic emulsion latex and a polyvinyl alcohol having a specific viscosity.

PVA used for the toner receiving layer 11, 21 and 22 according to the embodiments as illustrated in FIGS. 1 and 2 has an average viscosity of less than 25 cps in a 4% aqueous solution maintained at 20° C., in a range from 1.5 to 25 cps in a 4% aqueous solution maintained at 20° C., such as in a range from 3 to 20 cps in a 4% aqueous solution maintained at 20° C.

When latex only is used as a binder, during a high-speed coating process, e.g., blade coating, the coating solution exhibits dilatant flow characteristics at a high shear rate, lowering coating efficiency and ultimately deteriorating the quality of a product obtained thereby. To overcome such problems, PVA, which is a water-soluble polymer, is used, thereby strengthening the pseudo plastic flow characteristics of the coating solution.

Although any particular limitation is not imposed on the PVA exerting an effect of strengthening the pseudo plastic flow characteristics, when a PVA having a low density, i.e., having an average viscosity of less than 25 cps, is used in combination with the latex at 20° C. in a 4% aqueous solution, the strengthening effect becomes considerably high. However, when high-viscosity PVA is used at 20° C. in a 4% aqueous solution, that is, when the average viscosity of PVA used is higher than 25 cps, the viscosity of the coating solution to form the toner receiving layer may undesirably increase, resulting in an offset of the PVA effect.

If the content of PVA used is too low, an effect obtained by using the PVA as a binder is not properly attainable. Alternatively, if the content of the PVA is too high, costs may rise and stability of the coating solution may be adversely affected due to poor adhesion between the toner receiving layer and the substrate 10 and 20. In light of the foregoing, the toner receiving layer includes 1 to 100 parts by weight of the PVA, based on 100 parts by weight of the acrylic emulsion latex.

In order to form the toner receiving layer 11, 21 and 22 according to the embodiments as illustrated in FIGS. 1 and 2, the acrylic emulsion latex used as the binder together with the PVA can prepare a coating solution having good light fastness and high gloss, so as to be suitably used as a recording medium for an electrophotographic printer for color printing. In addition, the acrylic emulsion latex used as the binder together with the PVA can prepare a coating solution having high blister resistance in a high concentration, which can positively impact coating efficiency.

Examples of the useful acrylic emulsion latex include polyacrylate emulsions, styrene-acrylic copolymer emulsions and polyvinylacetate-acrylate copolymer emulsions. In an embodiment, polyvinylacetate-acrylate copolymer emulsion is used.

Final physical properties of general polymeric compounds are mostly affected by glass transition temperatures (Tg). In an embodiment, the glass transition temperature (Tg) of the acryl based emulsion latex is equal to or lower than about 40° C., such as in the range from −20 to 40° C. If Tg is higher than 40° C., a coating layer tends to be hardened, so that paper powder may fly when the paper is cut or torn. Moreover, the adhesion to the substrate 10 and 20 may be undesirably lowered. A number average molecular weight of the acrylic emulsion latex can be in a range from about 10,000 to about 5,000,000, such as in a range from about 50,000 to about 1,000,000.

If the content of the acrylic emulsion latex in the toner receiving layer is too low, the effect obtained by using the acrylic emulsion latex as the binder cannot be achieved. If the content of the acrylic emulsion latex in the toner receiving layer 11, 21 and 22 is too high, the excessive use may adversely affect printability. In light of the foregoing, the content of the acrylic emulsion latex may be suitably selected to range from about 5 to about 20 parts by weight based on the total solid content of the toner receiving layer.

In addition to the PVA and acrylic emulsion latex used as the binders, in order to improve physical properties of the toner receiving layer, the toner receiving layer 11, 21 and 22 according to an embodiment may further include one or more materials selected from the group consisting of polyvinylpyrrolidone, methyl cellulose, hydroxypropylmethyl cellulose, gelatin, polyethylene oxide, acryl based polymer, polyester, polyurethane, epoxy resin, styrene-butadiene based latex, vinyl nitrate based latex, methyl(meth)acrylate-butadiene based latex and quaternary ammonium-based copolymer.

The toner receiving layer 11, 21 and 22 formed on the substrate 10 and 20 may include a white pigment in addition to the PVA and acrylic emulsion latex used as the binders. Here, usable examples of the white pigment include inorganic pigments and/or organic pigments. The inorganic pigment has an average diameter of equal to or smaller than 2.5 μm, such as in a range from 2.0 to 0.1 μm. The inorganic pigment may be kaolin clay, silica, calcium carbonate, talc, aluminum hydroxide, satin white, titanium dioxide, calcined clay, zinc oxide, or barium sulfate. Examples of the organic pigment include styrene based resin such as polystyrene, or polymethylstyrene; acryl based resin such as polymethylmethacrylate, or polyacrylonitrile; polyvinyl chloride, polycarbonate, and so on. The organic pigment and the inorganic pigment may be used in combinations of two or more in an appropriate ratio.

The white pigment is present in a content ranging from about 100 to about 6,000 parts by weight based on 100 parts by weight of acrylic emulsion latex, such as from about 200 to about 3,000 parts by weight, and, in an embodiment, from about 400 to about 2,000 parts by weight. If the content of the white pigment is greater than 6,000 parts by weight, the adhesion between the toner receiving layer 11, 21 and 22 and the substrate 10 and 20 may be reduced. Alternatively, if the content of the white pigment is less than 100 parts by weight, most of the white pigment may be buried in the binder, so that the white pigment may not properly serve as a colorant.

The toner receiving layer according to an embodiment may further include polyethylene glycol, thereby improving flexibility and electric properties of the coating layer. A number average molecular weight of the polyethylene glycol ranges from about 150 to about 1,500. The number average molecular weight of the polyethylene glycol ranges from about 400 to about 800.

The content of the polyethylene glycol may be in a range from about 10 to about 200 parts by weight based on 100 parts by weight of acrylic emulsion latex. If the content of the polyethylene glycol is less than 10 parts by weight, the intended effect by using the polyethylene glycol cannot be attained. Alternatively, if the content of the polyethylene glycol is greater than 200 parts by weight, the toner receiving layer becomes overly soft and tacky, thereby deteriorating a paper feeding quality.

The toner receiving layer 11, 21 and 22 according to the embodiments as illustrated in FIGS. 1 and 2 may further include a defoamer, thereby promoting uniformity of the coating by suppressing generation of bubbles generated during high-speed coating. A phosphate-based compound can be used as the defoamer. Examples of the phosphate-based compound include, but are not limited to, alkylphosphate, tripolyphosphate, trialkane/alkenephosphate, and the like.

The content of the defoamer may be 0.001 to 2 parts by weight based on 100 parts by weight of the acrylic emulsion latex. If the content of the defoamer is less than 0.001 parts by weight, the effect obtained by using the defoamer is difficult to attain. If the content of the defoamer is greater than 2 parts by weight, the commercial availability of the coating solution may be undesirably lowered.

In order to improve image stability of a recording medium, or to improve stability of the toner image-receiving layer 11, 21 and 22, or enhance processability during a recording medium manufacturing process, the toner receiving layer 11, 21 and 22 according to the embodiments as illustrated in FIGS. 1 and 2 may further include various additives to compensate for physical properties thereof. The additives known in the art may be used, including antistatic agent, a cross-linking agent, a dye, a fluorescent whitening agent, a light dispersing agent, a pH adjusting agent, an antioxidant, a defoamer, a leveling agent, a lubricating agent, an anticurling agent, a surfactant, a thickener, an ultraviolet ray absorbent, an anti-aging agent, an ozone deterioration inhibitor, a preservative, a conductivity-donating agent, and so on.

The substrate 10 and 20 for use in the recording medium for an electrophotographic printer is not particularly limited and may be suitably selected in accordance with the intended purposes, provided that it is able to withstand a fixing temperature and meet requirements of planarity, turbidity, frictional property, electrostatic property, fixability, and the like. In detail, examples of the substrate 10 and 20 include paper substrates, such as synthetic paper (e.g., polyolefin-based synthetic paper or polystyrene-based synthetic paper), wood-free printing paper, art paper, coated paper, composite paper of paper and film, baryta paper, resin or emulsion impregnated paper, synthetic rubber latex impregnated paper, paperboard, or cellulose fiber sheet. Further, a plastic film substrate may be used. The plastic film substrate may be made of polyolefin, polyvinyl chloride, polyethylene terephthalate (PET), polystyrene, polymethacrylate, or polycarbonate. In addition, a white opaque film, or a foamed sheet, which is obtained by adding a white pigment or a filler to the synthetic resin, can also be used. These can also be used alone or in a layered structure in combination of two or more. For example, the 10 and 20 may have a layered structure of cellulose fiber paper and synthetic paper, or a layered structure of cellulose fiber paper and a plastic film.

The substrate 10 and 20 can have a high surface planarity. In detail, the substrate surface roughness (planarity) is equal to or greater than 210 seconds, such as equal to or greater than 250 seconds. If the planarity is less than 210 seconds, the quality of an image may deteriorate when the image is formed.

A thickness of the substrate 10 and 20 may be suitably selected in accordance with the intended use. Generally, the thickness ranges from about 25 μm to about 260 μm, such as from about 75 μm to about 220 μm.

In order to improve adhesion between the substrate 10 and 20 and the toner receiving layer formed under the substrate 10 and 20, the substrate 10 and 20 can be subjected to a primer treatment or a corona discharge treatment on a surface of the substrate 10 and 20.

In an alternative embodiment of the present general inventive concept, an outer coating may further be provided on a single-layered toner receiving layer. The outer coating is primarily provided for the purpose of further improving the gloss. That is, a gloss improving effect can be achieved by reducing a proportion of a white pigment to the toner receiving layer, or increasing a quantity of organic substance in the white pigment, e.g., a plastic pigment. The outer coating may be composed of a resin layer essentially consist of a binder.

The toner receiving layer 11, 21 and 22 can be prepared using the composition to form the toner receiving layer as a coating solution. That is, the coating solution is coated on a surface of the substrate 10 and 20 and dried to form the toner receiving layer. The composition to form the toner receiving layer includes 100 parts by weight of an acryl based emulsion latex, 1 to 200 parts by weight of PVA, 100 to 6,000 parts by weight of a white pigment, and 100 to 10,000 parts by weight of a solvent. The average viscosity of the PVA is less than 25 cps in a 4% aqueous solution maintained at 20° C. The acryl based emulsion latex, the PVA and the white pigment are the same as described above.

The solvent in the composition to form the toner receiving layer is not particularly limited, and water may be typically used in consideration of environmental concerns and workability. In addition to water, any solvent selected from the group consisting of ketones, glycol ethers, alcohols, methyl cellosolves, ethyl cellosolves, dimethylformamides, and dimethylsulfoxides may also be used. In more detail, examples of the usable ketones include acetone and methylethyl ketone, examples of the glycol ethers include diethylene glycol, and diethylene glycol monobutyl ether, and examples of the alcohols include methanol, ethanol, butanol, and isopropanol.

The solvent may be used in a content ranging from about 100 to 10,000 parts by weight, based on 100 parts by weight of the acrylic emulsion latex. If the content of the solvent is less than 100 parts by weight, viscosity may increase excessively and cracks may be generated or unwanted agglomeration may be caused, ultimately deteriorating coating surface properties. If the content of the solvent is greater than 10,000 parts by weight, drying of a coating layer may be impaired.

The composition to form the toner receiving layer has a solid content of equal to or greater than 30% by weight, such as from about 40 to about 80% by weight, and, in an embodiment, from about 50 to about 75% by weight.

The recording medium for an electrophotographic printer is prepared by coating the composition to form the toner receiving layer on one surface or both surfaces of the substrate 10 and 20, drying the composition and thus forming the toner receiving layer 11, 21 and 22. The coating operation may be carried out by blade coating, roll coating, or knife coating. The drying operation may be carried out at a temperature ranging from about 50° C. to about 130° C. for about 2 seconds to about 5 minutes. If a cross-linking agent is added to the toner receiving layer 11, 21 and 22, a cross-linkage reaction may be caused due to the presence of the cross-linking agent at the drying operation. In this regard, if the drying temperature is lower than 50° C., the cross-linking reactivity is lowered. If the drying temperature is higher than 130° C., a yellowing phenomenon may occur.

If the toner receiving layer 11, 21 and 22 formed is too thin, the toner receiving layer 11, 21 and 22 cannot serve properly. Alternatively, if the resulting toner receiving layer 11, 21 and 22 is too thick, a production cost may increase and drying of a coating layer may be impaired. In this regard, the toner receiving layer 11, 21 and 22 can have a thickness in the range from about 1 μm to about 30 μm.

The obtained recording medium for an electrophotographic printer according to an embodiment can be used in various printing apparatuses using laser beams, for example, a laser printer, a facsimile, a copier, and so on.

As described above, the recording medium for an electrophotographic printer according to the embodiments as illustrated in FIGS. 1 and 2 can be obtained by introducing a white pigment, an acrylic emulsion latex and PVA having an average viscosity of less than 25 cps in a 4% aqueous solution maintained at 20° C. to a toner receiving layer 11, 21 and 22, thereby achieving a high production yield and enhanced image quality with a uniform coating.

The present general inventive concept will be described in greater detail with reference to the following examples. The following examples are for illustrative purposes only and are not intended to limit the scope of the general inventive concept.

### EXAMPLE 1

A composition to form a toner receiving layer 11, 21 and 22 having the following formulation was prepared.

| | | |
|---|---|---|
| Potassium carbonate (SETACARB HG, Omya) | 80 | parts by weight |
| Hollow-sphere pigment (HP-150, Synature) | 3 | parts by weight |
| Latex (AE-156, Synature) | 8 | parts by weight |
| Low-viscosity PVA (PVA 110, Kuraray) | 1 | parts by weight |
| Thickener (VE-157, Synature) | 0.2 | parts by weight |
| Sodium chloride (Junsei) | 2.8 | parts by weight |
| Polyethylene glycol (Junsei) | 5 | parts by weight |
| Water | 53 | parts by weight |

The obtained composition to form the toner receiving layer 11, 21 and 22 was coated on an upper surface of base paper having a basis weight of 135 g/m² with a blade coater at a rate of ˜200 M/min and dried, to prepare a recording medium for an electrophotographic printer having the toner receiving layer 11, 21 and 22 contained in an amount of approximately 20 g/m².

### EXAMPLE 2

A composition to form a toner receiving layer 11, 21 and 22 having the following formulation was prepared.

| | | |
|---|---|---|
| Potassium carbonate (COVERCARB 75, Omya) | 81 | parts by weight |
| Hollow-sphere pigment (KP-90, Rohm & Haas) | 3 | parts by weight |
| Latex (AE-156, Synature) | 7.4 | parts by weight |
| Low-viscosity PVA (F-05, Dongyang Chemical Co.) | 0.8 | parts by weight |
| Thickener (VE-157, Synature) | 0.3 | parts by weight |
| White pigment (White T-90, Kemira) | 2 | parts by weight |
| Defoamer (D101A, Epteck) | 0.5 | parts by weight |
| Polyethylene glycol (Junsei) | 5 | parts by weight |
| Water | 53 | parts by weight |

The obtained composition to form the toner receiving layer 11, 21 and 22 was coated on both surfaces of base paper having a basis weight of 135 g/m² with a blade coater at a rate of ˜200 M/min and both surfaces of the base paper were dried to prepare a recording medium for an electrophotographic printer having the toner receiving layer 11, 21 and 22 contained on both surfaces in an amount of approximately 20 g/m².

### COMPARATIVE EXAMPLE 1

A recording medium for an electrophotographic printer was prepared in the same manner as in Example 1 except that a toner receiving layer 11, 21 and 22 had the following formulation.

| | | |
|---|---|---|
| Potassium carbonate (SETACARB HG, OMYA) | 80 | parts by weight |
| Hollow-sphere pigment (HP-150, Synature) | 3 | parts by weight |
| Latex (AE-156, Synature) | 9 | parts by weight |
| Thickener (VE-157, Synature) | 0.2 | parts by weight |
| Sodium chloride (Junsei) | 2.8 | parts by weight |
| Polyethylene glycol (Junsei) | 5 | parts by weight |
| Water | 53 | parts by weight |

### COMPARATIVE EXAMPLE 2

A recording medium for an electrophotographic printer was prepared in the same manner as in Example 2 except that a toner receiving layer 11, 21 and 22 had the following formulation.

| | | |
|---|---|---|
| Potassium carbonate (COVERCARB 75, Omya) | 81 | parts by weight |
| Hollow-sphere pigment (KP-90, Rohm & Haas) | 3 | parts by weight |
| Latex (AE-156, Synature) | 7.4 | parts by weight |
| High-viscosity PVA | 0.8 | parts by weight |
| (F-24, Dongyang Chemical Co.) | | |
| Thickener (VE-157, Synature) | 0.3 | parts by weight |
| White pigment (White T-90, Kemira) | 2 | parts by weight |
| Defoamer (D101A, Epteck) | 0.5 | parts by weight |
| Polyethylene glycol (Junsei) | 5 | parts by weight |
| Water | 53 | parts by weight |

Table 1 illustrates the average viscosity of each type of PVA used in Examples 1 and 2 and Comparative Example 2.

TABLE 1

| | | | Comparative |
|---|---|---|---|
| | Example 1 | Example 2 | Example 2 |
| | (Type: PVA-110) | (Type: F-05) | (Type: F-24) |
| Average | 10.5 | 5.6 | 60 |
| Viscosity (cps) | | | |

Average viscosity was measured using a Brookfield viscometer at 20° C. in 4% aqueous solution.

Image printing was performed on the ink-jet recording media for an electrophotographic printer according to Examples 1 and 2 and Comparative Examples 1 and 2 using a color laser beam printer (CLP-300, Samsung, Korea). For each electrophotographic printing image obtained, surface appearance image quality was evaluated in the following manner.

In detail, in order to evaluate surface appearance image quality of each recording media for an electrophotographic printer according to Examples 1 and 2 and Comparative Examples 1 and 2, the planarity of a coating surface and occurrence of streaks were determined. In addition, after printing, the gloss was measured, which is one type of indirect method of evaluating the coating surface uniformity. That is to say, if a coating surface has high planarity and uniformity, the gloss tends to be higher. Table 2 illustrates the evaluation results.

TABLE 2

| | | | | Com- | Com- |
|---|---|---|---|---|---|
| | | | | parative | parative |
| | | Example 1 | Example 2 | Example 1 | Example 2 |
| Surface | Planarity | □ | □ | x | Δ |
| appearance | Streak | ∘ | ∘ | Δ | Δ |
| image | | | | | |
| quality | | | | | |

| | | | | |
|---|---|---|---|---|
| 60-degree gloss after | 36 | 41 | 13 | 22 |
| printing | | | | |

□: Excellent,
∘: Good,
Δ: Poor,
x: Very poor

As illustrated in Table 2, the recording media for an electrophotographic printer according to Examples 1 and 2 include an acrylic emulsion latex and low-viscosity PVA, and as such suppresses occurrence of streak, increases production yield and enhances image quality with a uniform coating.

Alternatively, the recording medium according to Comparative Example 1 has poor planarity and high occurrence of streak, resulting in a poor production yield.

In Comparative Example 2 in which high-viscosity PVA is used, there was a slight improvement in view of the planarity and the gloss after printing, compared to Comparative Example 1, but the extent of the improvement was still insufficient. Moreover, regarding streaks, there was little improvement observed. Accordingly, when the acrylic emulsion latex and PVA having an average viscosity of less than 20 cps in a 4% aqueous solution maintained at 20° C. are concurrently used, the production yield and the planarity of a coating surface can be enhanced by improving the coating uniformity during a high-speed coating process, e.g., blade coating.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A recording medium used with an electrophotographic printer, the recording medium comprising:
a substrate; and
a toner receiving layer formed on at least one surface of the substrate,
wherein the toner receiving layer includes a white pigment, an acryl based emulsion latex and polyvinyl alcohol, and an average viscosity of the polyvinyl alcohol is less than 25 cps in a 4% aqueous solution maintained at 20° C.

2. The recording medium of claim 1, wherein the average viscosity of the polyvinyl alcohol ranges from 1.5 to 25 cps in a 4% aqueous solution maintained at 20° C.

3. The recording medium of claim 1, wherein the average viscosity of the polyvinyl alcohol ranges from 3 to 20 cps in a 4% aqueous solution maintained at 20° C.

4. The recording medium of claim 1, wherein the toner receiving layer includes 100 parts by weight of the acryl based emulsion latex, 1 to 100 parts by weight of the polyvinyl alcohol and 100 to 6,000 parts by weight of the white pigment.

5. The recording medium of claim 1, wherein the glass transition temperature (Tg) of the acryl based emulsion latex is equal to or lower than about 40° C.

6. The recording medium of claim 1, wherein a number average molecular weight of the acryl based emulsion latex ranges from about 10,000 to about 5,000,000.

7. The recording medium of claim 1, wherein the acryl based emulsion latex is at least one selected from the group consisting of polyacrylate emulsions, styrene-acrylic copolymer emulsions and polyvinylacetate-acrylate copolymer emulsions.

8. The recording medium of claim 1, wherein the toner receiving layer further comprises:
polyethylene glycol.

9. The recording medium of claim 8, wherein a content of the polyethylene glycol is in a range of 10 to 200 parts by weight per 100 parts by weight of the acryl based emulsion latex.

10. The recording medium of claim 8, wherein a number average molecular weight of the polyethylene glycol ranges from about 150 to about 1,500.

11. The recording medium of claim 1, wherein the toner receiving layer further comprises:
a defoamer.

12. The recording medium of claim 1, wherein a content of the defoamer is in a range of 0.001 to 2 parts by weight per 100 parts by weight of the acryl based emulsion latex.

13. The recording medium of claim 11, wherein the defoamer comprises:
a phosphate based compound.

14. The recording medium of claim 1, wherein the toner receiving layer comprises:
one or more material selected from the group consisting of polyvinylpyrrolidone, methyl cellulose, hydroxypropylmethyl cellulose, gelatin, polyethylene oxide, acryl based polymer, polyester, polyurethane, epoxy resin, styrene-butadiene based latex, vinyl nitrate based latex, methyl(meth)acrylate-butadiene based latex and quaternary ammonium-based copolymer.

15. The recording medium of claim 1, wherein the toner receiving layer is formed on both surfaces of the substrate.

16. A composition to form a toner receiving layer comprising:
a white pigment, an acryl based emulsion latex, polyvinyl alcohol and a solvent, wherein an average viscosity of the polyvinyl alcohol is less than 25 cps in a 4% aqueous solution maintained at 20° C.

17. The composition of claim 16, wherein a content of the acryl based emulsion latex is about 100 parts by weight, a content of the polyvinyl alcohol is in a range of about 1 to about 100 parts by weight, a content of the white pigment is in a range of about 100 to about 6,000 parts by weight, and a content of the solvent is in a range of about 100 to about 10,000 parts by weight.

18. The composition of claim 16, wherein the solvent is one or more material selected from the group consisting of water, ketones, glycol ethers, alcohols, methyl cellosolves, ethyl cellosolves, dimethylformamides, and dimethylsulfoxides.

19. The composition of claim 16, further comprising:
at least one of polyethylene glycol or a defoamer.

20. The composition of claim 16, wherein a solid content of the composition is equal to or greater than 30 parts by weight.

21. The composition of claim 16, wherein a solid content of the composition is in a range of about 40 to about 80 parts by weight.
